(19) United States
(12) Patent Application Publication
(10) Pub. No.: US 2014/0295383 A1
(43) Pub. Date: Oct. 2, 2014

(54) PROCESSES AND METHODS TO USE PICTURES AS A LANGUAGE VEHICLE

(71) Applicant: Carlos Rodriguez, (US)

(72) Inventor: Carlos Rodriguez, Madrid (ES)

(21) Appl. No.: 13/853,052

(22) Filed: Mar. 29, 2013

(51) Int. Cl. G09B 19/06

(52) U.S. Cl. CPC G09B 19/06
USPC 434/157; 434/156

(57) ABSTRACT

I disclose processes and methods that by combining pictures in specific ways could boost, enforce, and optimize language learning. Herein I disclose the combination of several pictures all of them related to the same word in order to elicit said word in the observer. Also, by showing a word together with several photos, and by having to choose the photo/s related to the word, the observer can enforce the word learning process. Moreover, I describe the replacement headers of classical multi-choice questions with a photograph. I also show that by intermingling pictures and words, photos can become language units in the same token as conventional words. Finally as a practical embodiment of this method, I provide a game that can be both entertaining and educational.

### OTHER PUBLICATIONS

Houts P S, Witmer J T, Egeth H E, Loscalzo M J, Zabora J R. (2001). Using pictographs to enhance recall of spoken medical instructions II.

### Patient Educ Couns pp: 231-42.

Schlochtermeier L H, Kuchinke L, Pehrs C, Urton K, Kappelhoff H, Jacobs A M. (2013). Emotional picture and word processing: an FMRI study on effects of stimulus complexity. PLoS One. pp: e55619.

Tare M, Gelman S A. (2010). Determining that a label is kind-referring: factors that influence children's and adults' novel word extensions.

### J Child Lang. pp: 1007-26.

### BACKGROUND OF THE INVENTION

a. Field of the Invention

The subject invention relates to processes, in particular to those based on analysing and interpreting pictures as well as combining and associating them with words in specific manners.

b. Related Arts

That pictures are not the same as words seems to be an obvious statement, but it has been widely shown that a type of realistic pictures like photographs elicit emotional responses that are different to the responses elicited by words represented by photographs. Moreover, the language extension response to photos is different in pre-school children as compared with adults. Indeed, when preschool-aged children are asked to ‘find another’ example of a novel word after being shown a picture (e.g. the picture of a baseball), they choose shape responses (e.g. orange), more than taxonomic responses (e.g. a basketball, or a football, etc.), whereas adults choose taxonomic choices more often.

Other than conventional modern written languages (i.e conventional words constructed from alphabets), graphic representations conveying words or more complex meanings can be (in a limited non exhaustive list) of different kinds:
Symbols are particular marks that represent some piece of information
Ideograms or ideographs that is a graphic symbol that represents an idea or concept.
Pictograms, are ideograms that resemble the physical object they represent.
Pictographs are a type of pictograms that have a pictorial appearance. For instance, traffic or informative signs. There are also games based on pictographs (pictograph game, pictographic labyrinth, etc.).
Drawings: works produced by representing objects or forms on a surface chiefly by means of lines.
Images: They record perceptions that have similar appearance to some subject, thus providing a depiction of it.
Photographs or photos are images that capture the light of real life objects usually on a film or an electronic image such as a chip.
   Photos constitute a particularly interesting case in that they are the more faithful graphic reproduction of reality among the representations in the non-extensive list above.

In recent years there has been a proliferation of open access sites that make use of photographs or pictures to convey, reinforce, underline or interpret a text. In these compositions, the picture usually plays a secondary role as the background, tone, brightness of a preferred text (a poem, a quote, a statement, etc.).

For instance in some open access places like “sayingimages.com” what is shown is a set of pictures overlaid by words: In this format, pictures serve as a background to enforce or to underline a text, such for example a poem. Similar combinations can be found in quotes and images, although in this case the text and the associated picture are physically separated. Other interesting sites that work around the same concept can be found in “Pinterest.com”, “photoswordspeople.com”, “sadanduseless.com”,

An interesting case of a method to develop language skills is The Picture Word Inductive Model (PWIM) originally developed by Emily Calhoun and aimed at teaching of reading a language. It uses pictures containing familiar objects, actions and scenes, to draw out familiar words from students' listening and speaking vocabularies. This strategy is aimed at helping students add words to their sight reading vocabulary, as well as their writing vocabulary, and to examine and categorize phonetic and structural principles present in those words.

With the advent of the digital era (and particularly in the last decade), image/photo repositories/galleries have exponentially grown. Nowadays one can for instance search for images using simple key words in an online search engine and find thousands of images that correspond to the word entry. So that, if one want to represent a specific word, it is relatively easy to find the corresponding images/pictures by searching in the internet.

### ORIGINS OF THE INVENTION

Although they have the advantage of immediately raise memories or complex thoughts in the observer's mind (something that may not occur with more simple depictions like pictograms, or, particularly ideograms), photos, as single, isolated images, however, are not necessarily the best representations of words. In fact, particularly in the case of object representation but also in many other cases such as actions, etc., photographs can have a disadvantage when compared with more symbolic simple depictions. Indeed, in addition to the subject/action of interest, photos capture all the details of the environment, being thus by definition a complex image of the subject of interest.

I thus thought that perhaps by combining pictures all of them being related to the same word, one could overcome this caveat and, therefore, any observer could automatically think in the right word by unconsciously excluding subjects/actions that are not present in all the pictures of the combination, and therefore are not relevant to the process.

By playing myself a spontaneous game, I started to realize the potential of combining pictures in order to convey a specific word. At the beginning, I used open access repositories like Flickr Creative Commons, but I soon realized that, if I wanted to really produce the desired combination, I needed to take my own pictures, thinking already, while shooting the pictures, in the final shape that the combination of photos will take for a given word.

After performing preliminary tests with friends and family, I soon realized the potential of photo based combinations as a basic process to be of utility in language acquisition, language learning, and language extension. In addition, I clearly saw that by asking my Spanish family members to guess the right word in English, after being shown a number of these combinations, they would remember many of the words that they had to guess (in some cases, after having to use a dictionary). Indeed, they had acquired a very valuable new vocabulary just by playing and having fun with a very simple use of one of the processes of the invention.

Further delving into the original idea, I have developed a system that is now essentially based on the use of pictures as surrogate units of any language.

The present patent disclosure is thus a continuation and completion of the provisional application (U.S. 61/617,401).

### BRIEF SUMMARY OF THE INVENTION

I provide herein new processes and methods that take advantage of the specific combination of different modules (particularly pictures and words).

In a first embodiment of the invention pictures can be combined in such a way that they can be immediately and unmistakably associated with a word or a meaning and only with one. The key to develop this method is to create a multi-photographic context of said picture, or a written language context, or, in some cases, a context that is a mixture of photos and written language. This can be otherwise explained by using examples. For instance, an object (and the word thereof) shown in a single photo can elicit a variety of words/meanings in the observer's mind. However, three or four photos showing different aspects of said object, immediately convey the word thereof. In this particular case, the multi-photographic context are other meaningful photos (e.g. all the photos relate to one word and only to one word).

Conversely, one can single out a photo among a variety of them provided that we simultaneously show the written word that is associated with said photo. In this particular embodiment of the method, the multi-photographic context are bulk photos that are unrelated to the written word or that have a non-meaningful relationship with it (e.g. the word represented by one bulk photo could sound similar to the written word that is shown in this particular embodiment).

In yet another embodiment of the process, one can use a photo to partially or totally substitute the heading in a classical multi-choice test. Photographs thereof can represent simple objects (e.g. a car) or can be as complex as needed in order to make the wording of the question partially or, even, completely unnecessary. In this particular form, the context of said picture is the written language (i.e. the text in the multi-choice question)

In yet another embodiment, photos can be intermingled with text in such a way that they become language units that can be integrated in the written language as surrogate words or even more complex language compositions like phrases, sentences or paragraphs.

Although a preferred embodiment of this invention is the use of photographs as the image part of the different processes above, it is easy to imagine for one skilled in the art that any form of image (like pictures, drawings symbols, shadows, etc.) can substitute or combine in any way (for instance one photo, one drawing and one symbol can the three of them relate to the same word and only to that word, etc.).

Finally and as a way of practical example of this methodology, I disclose a game that makes use of some of these processes and that can be both entertaining and educational, by challenging the player's ability to associate words with pictures. The board game that I disclose here is just an example of the multiple applications of the processes and methods of this patent disclosure.

### BRIEF DESCRIPTION OF THE FIGURES

FIG. 1 shows three different results (with different degrees of difficulty) of combining pictures related to the same word (in 1a, the word is mushroom; in 1b, belfry; and in 1c, cereals)

FIG. 2 shows two of the many possible ways of displaying a set of photos and a word that is related to at least one of the pictures (only one picture (A) in 2a; and two pictures in 2b)

FIG. 3 contains two different WORDING SUBSTITUTING IMAGE multi-choice questions (2a represents a symbol for video vigilance; and 2b contains a picture of hangers, the right answer being D).

FIG. 4 displays photographs and numbers representing single words (spider, feet, eight). The figure shows different combinations of actual words together with images and numbers.

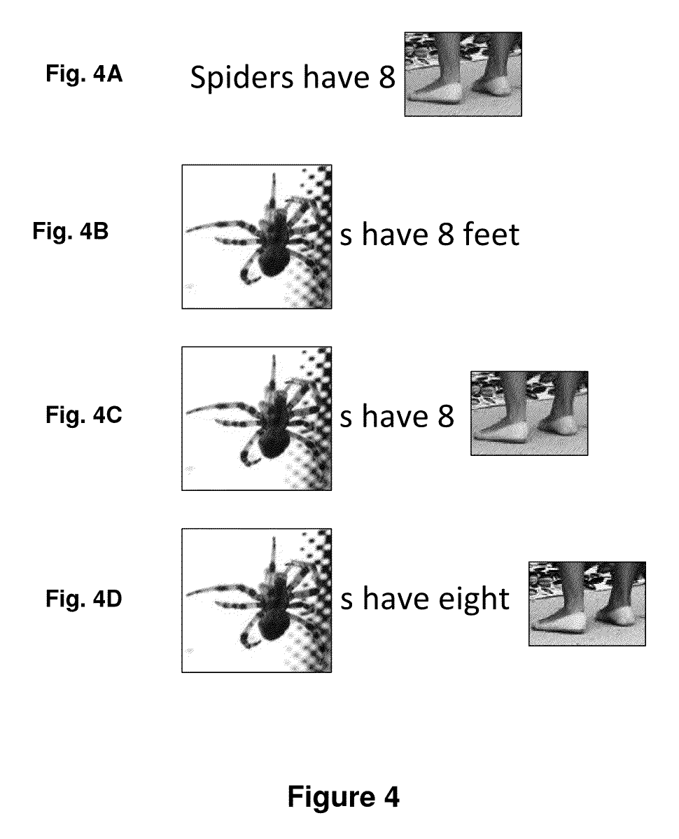

FIG. 5 is a depiction of the game board (a pyramid viewed from above the zenith) with four equilateral triangles each containing the exact copy of the game track.

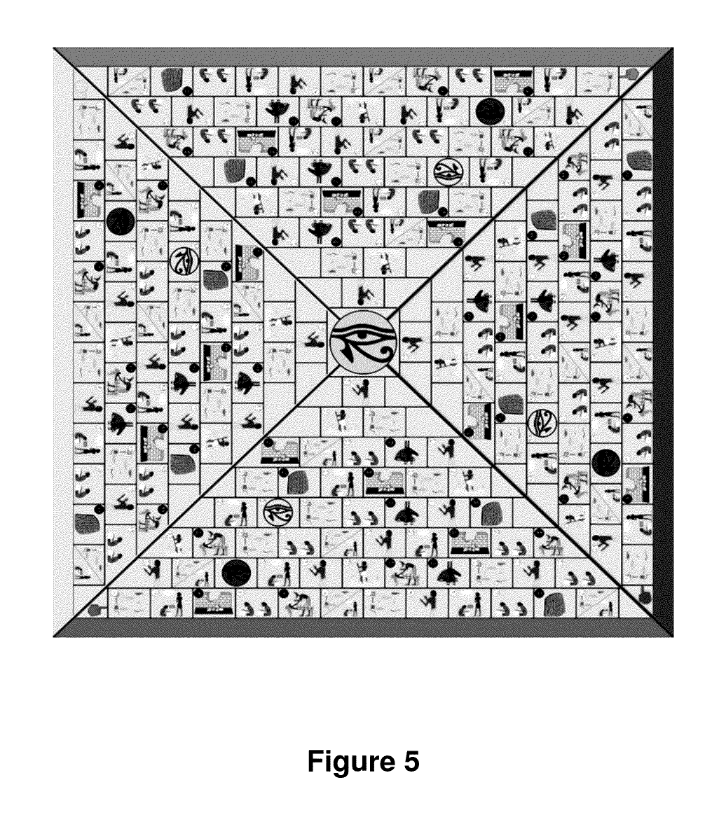

FIG. 6 offers a detailed vision of the different types of cases that players can encounter while going through the board game track.

FIG. 7 shows both sides of the typical game cards

### DETAILED DESCRIPTION OF THE INVENTION

In these invention, the use of photographs as essential components of the different processes is preferred to other forms of graphic representations like (without exhausting the list of different types of depictions) ideograms, pictograms, drawings, images or any other form of visual representation known by the skilled in the art. Also, although a preferred version of this invention uses different combinations of photos or of photos and words, in other imaginable forms of the invention, photos can be substituted by other kind of graphic representations like in the list above or simply combined with one or more types of depictions above. The only condition being that the actual structure of the processes described below is maintained.

### EXAMPLES

### Example 1

### A Set of Photos Conveying a Unique Word

In the provisional application related to the present filing, I described an art of combining pictures in a way to convey one word and only one word. A word in this combination can be an adjective, a name, a verb, an adverb, a pronoun or any other part of the speech. Depending on the type of use that one could give to the invention, the different parts of the speech that a given word can play could easily be codified (as in the game bellow) in order to direct the observer to the right word. Otherwise, genders or plural or singular forms of words can be either negligible or required, again depending on the use of said combination. When required, they can also be codified as in the game below. This process of the invention usually comprise three pictures but it can contain any number of them as long as they all relate to the same word and only to the same word.

As a way of example, one can imagine a picture that shows a mushroom in the middle of the grass with a backyard and a house in the background. Depending on our interests, our frame of mind, even our culinary preferences, or any other circumstance that can influence our way of thinking, the picture can elicit the word mushroom, but also the word grass, the word backyard, the word house, the word peace, the word work, etc. It can also elicit more complex language units like sentences, phrases, paragraphs or simply verbally nonconcrete thoughts. Said picture in the example can also elicit emotions that can or cannot have any connection with the mushroom. However, by showing for instance three pictures: the one of the example, another one of mushrooms being fried and another one of an amanita phalloydes (the one of red color with white spots), one would immediately think in the word mushroom and only in that word.

As in any of the processes in this invention henceforth, said combination can be of any number of pictures (ideally three or four per word). Also pictures in this embodiment are preferably photographs but can be any combination of any type of depiction that one skilled in the art can be aware of (including, pictograms, drawings, symbols, etc.).

### Example 2

### Combining a Set of Photos and a Written Word

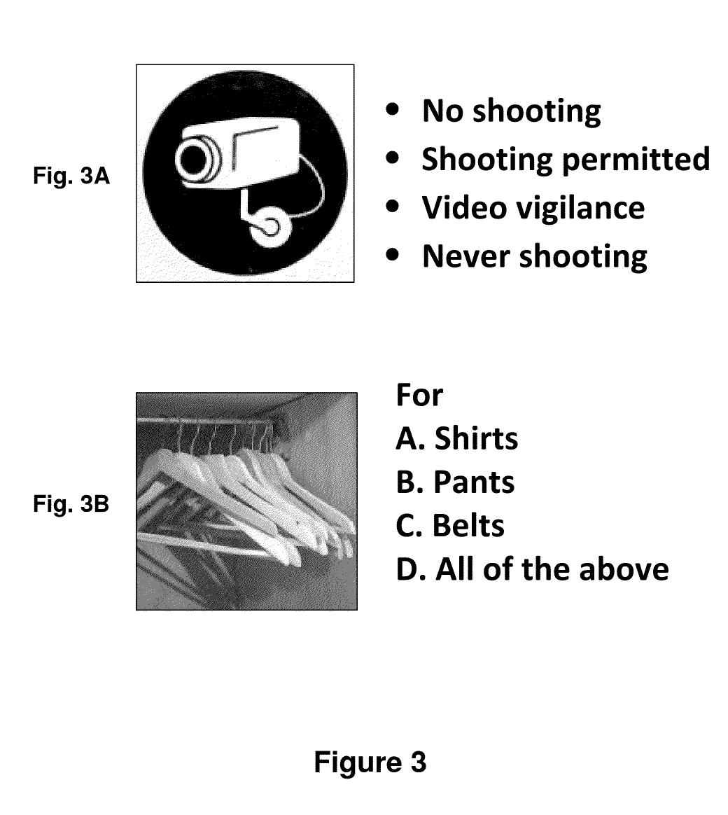

This combination consists in a number of photographs that are displayed together with a word being related to one (and, in general only to one) of the photographs thereof. A variation of this embodiment relates to showing a word and more than one picture matching that word. In this example, one of the places reserved for a picture in the question interface will be occupied by a text, that would indicate the possibility that the right answer is x and y (in the example FIG. 3b, A and C) instead of only one photograph. This example although a preferred embodiment of the idea does not exhaust by any means all the possibilities of including more than one “right” picture. Another variation of the invention consists in displaying a set of pictures (typically three but one can add any number of pictures in this particular embodiment) and a case containing a text like in the previous embodiment. The text in this case would read “None of the pictures” implying that this case could correspond to the right solution (or not, depending on the whether there are picture mach/es to the word or not in the combination of photos). Yet another embodiment of this invention is the combination of a variety of pictures with a language unit other than a word (i.e. without exhausting by any mean all the possible units of a human language, a phrase, a sentence, a paragraph, etc.).

This embodiment of the invention (i.e. the combination of a set of photos and a single word) is particularly fitted for computer games (and more specifically mobile games) with touch screens because in those types of apparatus it is possible to click the right answer by simply pressing/touching on the right picture without having to do any taping.

### Example 3

### A Heading Substituting Photo (HSP) Multi-Choice Test

The invention herein is based on a central piece, an image (typically a photograph but it can be any type of image that conveys a key object, an action, a position, etc.) which purpose in a multi-choice test is to be self-explanatory, rendering the heading of a test unnecessary or, in some cases, very short and simple (see FIG. 3b wherein the verbal heading of the test is just “For”). In order to elaborate these tests one would therefore only need an image and a series of written answer options (typically A, B, C, and D) that, for the easiness of the game, consist usually of a single word or a very short phrase. Images in multi-choice tests can be photographs from everyday's life, drawings, symbols, signs (such as traffic signs, information signs, etc.), icons, etc., the only requirement in order to be used herein being that they could have at least one consensual meaning for the general public (independently of the language they speak). This type of method should be very well suited for people who understand very little of a foreign language but that have an understanding of everyday's life so they can recognize objects, actions, etc. just by correctly interpreting the picture.

### Example 4

### Photographs as Language Units

The method under this header is based on the use of images being as a surrogate text (word/phrase/sentence) that has to be completed with actual words/text. It is what I call Wording Substituting Image (WSI). WSIs can be as small as a word (i.e. a part of the speech), or as big/long as a phrase or a whole sentence.

In a preferred embodiment, this process can be used to learn a foreign language. By substituting a word, a phrase, or a whole sentence with an image, a WSI automatically spares the observer/student the work of having to “translate” from the foreign language in order to understand the whole sentence. Automatic translation is actually a normal mechanism in foreign language learning and it usually makes the learning process heavier and slower than it would be, should the student “think” the sentence directly in the foreign language. By using the WSI method one can focus on a part of the speech and thus learn/teach otherwise advanced lessons to students with very limited knowledge of the foreign language. Those students do not need to understand complex sentences, but only the word or words that lay in between images or photographs.

Although learning a foreign language is a preferred application of the previous four examples (as in EXAMPLE 1, EXAMPLE 2, EXAMPLE 3, and EXAMPLE 4), the methods and processes can be also applied to learning all possible aspects of the native language (including, in a non-exhausting list, reading, writing, grammar, vocabulary, etc.).

### Application 1: A Board Game

I provide in this disclosure one of the many possible formats in which a game based on the invention herein can be encapsulated, namely a board game. The board takes the shape of a pyramid viewed from above with four identical sides. This, better than a single triangle of the pyramid, allows four teams of players to play the same match, each team having its own side of the pyramid as playing ground. Other aspects of the board are the Egyptian motifs that identify the four main types of challenges as well as a number of “traps/pits” spaces/places that make for a dynamic entertaining contest. There is also a “story” that serves as an argument background for the game. The story is based on the quest for the Orus eye as a means to rescue the head of the goddess Hathor from the grips of the bad guy (Seth, the creature of the desert).

The game however can be played on any possible physical surface or digital interface provided that, in order to advance in the game and eventually win it, the player/s need to answer questions that demand the association of pictures/photographs with language units (typically words) such as in the questions GUESS THE WORD, HSP multi-choice test.

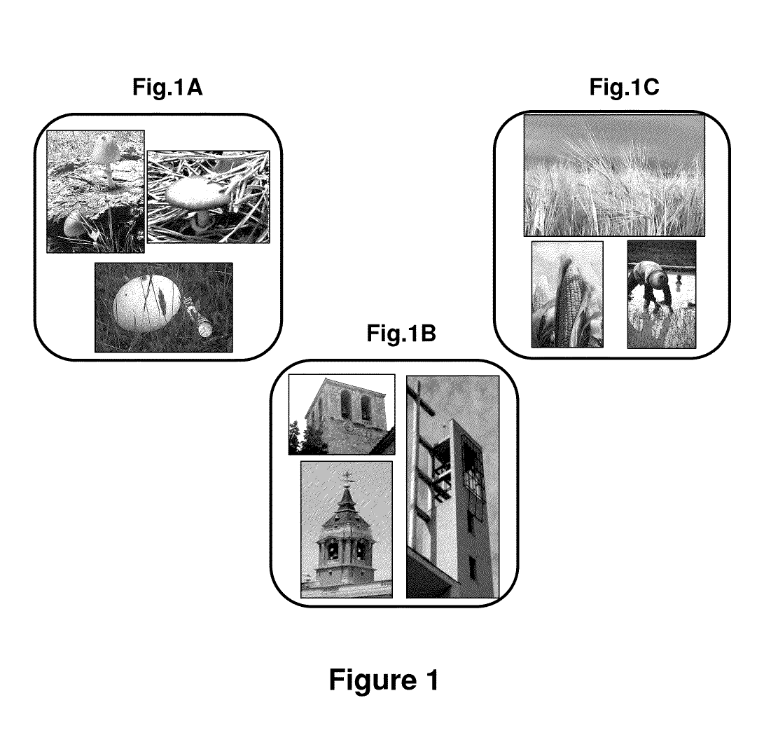

In order to move through the board, each team will have a playing token or piece that imitates the shape of a Hathor column that essentially consists in a column colored base (the color of the column base identifies each team) and an empty transparent cylinder (FIG. 1a).

As described later, when a team reaches an Orus Eye square, it gets a corresponding pillar (bronze, silver or gold) which is inserted into the cylinder, so the players can recognize the achievement/level reached by the team. The cylinder has enough room to accommodate the three pillars (on top of each other) (FIG. 1b) as well as the final cap (Hathor's head column capital) on top of them all.

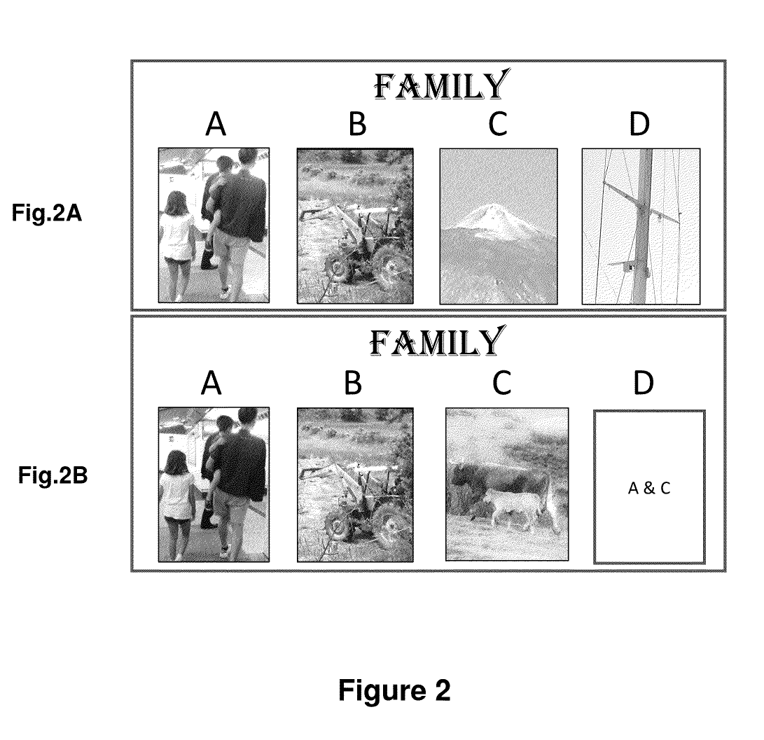

The board is a square of 60×60 cm and represents a pyramid viewed from above. The board is therefore divided into four identical triangles, each of them being the playing ground for one team. In total, there is place for four teams, each of them playing on independent playgrounds (FIG. 2).

Each playing ground (i.e. triangle) contains 96 playing squares represented by pyramid stone blocks. The playing squares or cases are numbered from 1 to 96 indicating the direction of game progress. Each playing square is drawing-coded and can be either a question, that the player needs to correctly answer in order to advance; a trap, that forces the player to drop the turn and in some cases to answer further questions in order to get out of it; advance cases; or graduation cases, that signal that the player has reached a specific knowledge level (bronze, silver and gold) (all the different types of challenges can be visualized in FIG. 3).

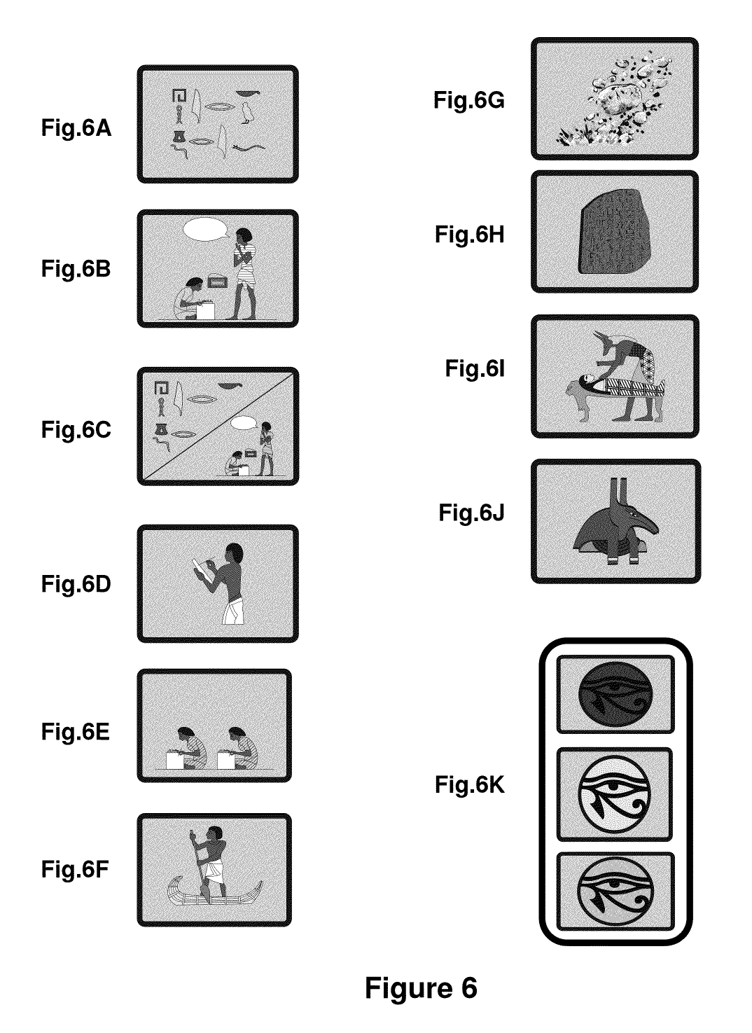

After the dice toss, players can land in any of the following squares or cases (the different types of cases as depicted in FIG. 6):

GUESS THE WORD (FIG. 6B): Landing on this square means that the team at play has to answer a question in order to continue to play (throw the dice). The question consists in combinations of two or more images (usually three pictures), all of them symbolizing the right word). Said word can be any part of the speech such as a name, and adjective, a verb, etc. As a lead for the player, the part of the speech that a word plays is indicated with a shape and color code in the upper right corner of the card. The right answer to this challenge is written in the back side of the card together with acceptable synonyms.

SAY THE WORD (FIG. 6B): This challenge is represented by a standing ancient Egyptian in the act of speaking (symbolized by a speaking cloud). When landing in this square, a member of the playing team (the explainer) will be shown a word in the own explainer language, after what, the explainer has to convey in the foreign language of the game the meaning of the word to the rest of the team, in such a way that, without mentioning said word, the team could be able to guess the right word. The right definitive answer is written in the back of the card. In order to successfully complete the challenge, the “explainer” needs to comply to some restrictions: no mimics, no mentioning of the word, no scrabbling, no drawing).

CHOICE (FIG. 6C): The players falling in this case have the choice of being asked either a “GUESS THE WORD” or a “SAY THE WORD” question.

WRITE THE WORD (FIG. 6D): This challenge is essentially the same as in SAY THE WORD, the difference being that the explainer has to convey the word by writing in the foreign language of this version of the game, having the same restrictions as in say the word (no mimics, no mentioning of the word, no scrabbling, no drawing).

CHECK (FIG. 6E): The check case indicates that the player/s have to respond to a HSP multi-choice test.

THE BARGE (FIG. 6F): When landing in the barge, the team automatically advances three squares and continue to play (roll the dice again).

COLLAPSE (FIG. 6G): Teams landing in this square have to skip one turn, thus allowing the next team in queue to play.

GO TO THE LIBRARY (FIG. 6H): When landing in this square, the team at play has to skip to the next team in turn. In addition, in the next turn, and in order to get out of the square, the team has to answer one challenge from the four different challenges of a typical game card

THE CRYPT (FIG. 6I): The crypt is a skipping case and also a penalty one. The team landing in this square ought to skip to the next team in turn and, in addition, in order to get out of the box, has to answer to two questions out of the three available in a card (i.e. “GUESS THE WORD”, a HSP multi-choice test and “Say the Word/Write the Word”).

THE SETH SQUARE (FIG. 6J): It is a skipping case and the biggest punishment in the game: at the next turn and to be able to get out of the trap, the team has to answer all three questions in a card (GUESS THE WORD, HSP multi-choice test, and either SAY THE WORD or WRITE THE WORD)

THE ORUS EYE (FIG. 6K): Each eye (bronze, silver and gold) are a step further in the race to get the capital of the Hathor column. Once reaching this square, teams have to answer the four questions in a corresponding (bronze, silver, or gold) card (H, CH, SAY THE WORD & WRITE THE WORD). The team can either a) give the correct answer to all the questions, in which case it continues to play in the next level (silver or gold), b) fail to answer one of the challenges, in which case it has to skip to the next team and, at the next turn, only answer to the remaining challenges (the previously correctly answered questions are kept as valid). After completing the test, the team is rewarded with a pillar in the same color as the level reached (bronze, silver, or gold), so that after reaching the golden Orus eye the column will be completed with three pillars. The first team that completes the required tests at the golden eye is rewarded with the goddess head (the column capital), and proclaimed winner of the game.

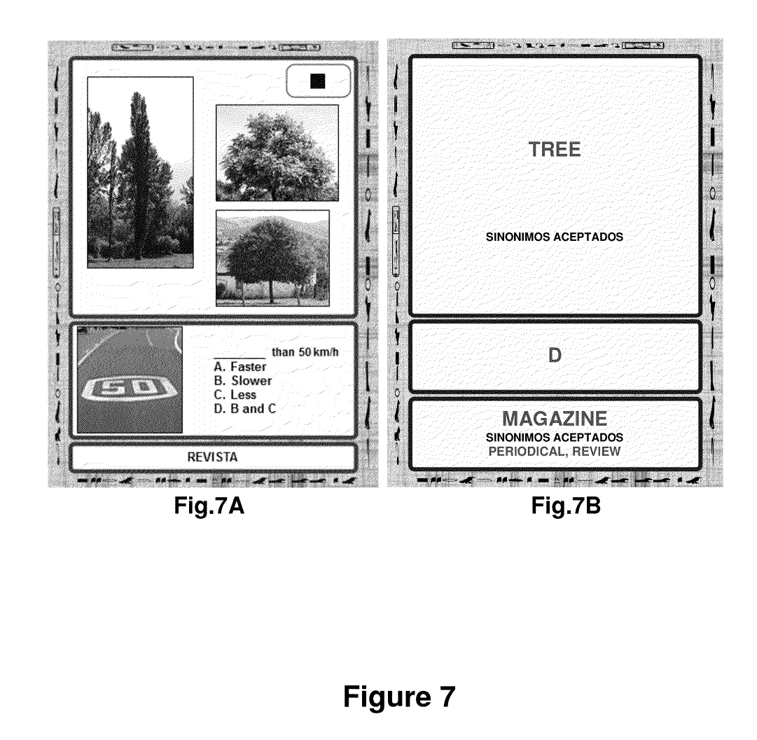

Cards (FIG. 7)

On the front side and from top to bottom, there is a GUESS THE WORD question. Below the hieroglyph there is a WORDING SUBSTITUTING IMAGE check/test with all the text (enunciate and usually four options) in the same language. Finally, on the bottom part of the card there is a word in the native language of the player that is to be shown to the “explainer” of “say the word” or “write the word”.

On the back side, there are the correct answers in red as well as the acceptable synonyms when applicable. For any question containing images (pictures, photographs or any other embodiment of the word image) the answer is always in the same language as the wording in the picture containing questions. For instance, in the English version of the game, although the instructions can be written in any language of choice, the wording in the WORDING SUBSTITUTING IMAGE multi-choice question or the word in the MULTIPICTURE question, as well as the right answer for the GUESS THE WORD question will all be written in English. The same concept will apply for the Spanish version of the game or any other version in any other human language.

The cards will be color coded (bronze, silver and gold) to indicate the degree of difficulty of the questions (from low to high, respectively). There are three stacks of cards with their corresponding box. The teams at play will draw the different card types depending in the track zone of the board on which they are situated (bronze, before the bronze Orus Eye case, silver, thereafter and until the silver Orus Eye case, and gold till the end (case number 96).

INFORMATIVE TEXT: By “informative text”, I mean all the texts that contribute to instruct the player on how to play the game, including the game instructions themselves (e.g. the rules of the game) that are part of a separate document contained in the Game box, all other text that helps the player to understand the game (in particular everything related to the rules of the game), all the explanatory headers in cards or anywhere else as for instance the headers in the back of the card (“AUTHORIZED SYNONYMS:”, “ANSWER:” “CORRECT ANSWER:”, “CORRECT WORD”, etc.). The term game instructions does not refer to any of the following: the text in the WORDING SUBSTITUTING IMAGE question, the word in the MULTIPICTURE choice question, the particular right answers to each question in the back of the game cards.

PROPER GAME WORDING: As “proper game wording”, I refer to any of the following: the text in the WORDING SUBSTITUTING IMAGE question, the word in the MULTIPICTURE choice question, the particular right answers to each question in the back of the game cards.

GAME LANGUAGE/S: Among the many possible ways of playing the image/photo word game, and assuming for those skilled in the art that the game can be played in a sole language (including the native language of the players), a preferred embodiment is a game to learn a foreign language, in which, and as a general rule, the game “informative texts” (instructions, guidelines, rules, explanatory card headings, etc.) will be written in the native language of the country (e.g. the players) in which the game will be sold/played. For instance, in Spain, the game informative texts will be in Spanish, in Germany, in German, in the USA in English, and so on. The “proper game wording” (e.g. the text in the HSP question, or the right answers to each question in the back of the game cards) however will be written in the language of interest (for instance, English if the language to be practiced/learned is English, etc.).

In order to dynamically play the game, it is recommendable that the language of interest be minimally known by all or most of the players. To have any knowledge of the foreign language at all, however, is not an absolutely necessary condition to play the game. In a preferred hypothetical circumstance, I can imagine a game in which there are at least two players per team with minimal knowledge of the foreign language and one player per team without any knowledge of the foreign language.

THE DICTIONARY: Games in two languages (language A and language B) will have its own dictionary to allow translation from language A to language B and vice versa. The GRADUATION DICTIONARY will have however certain peculiarities with respect to traditional language translation dictionaries. For instance, entrances (particularly in the “Language A Language B” part) can be single words in singular, in plural, verb tenses, idioms, or, in some cases, even entire phases. These variations have been introduced in order to facilitate a quick search (especially in the check challenge).

THE BOX: The box contains all the necessary pieces to play the game. They are stored in several compartments (e.g. boxes): one for the bronze cards, one for silver cards, one for golden cards, (transparent box) for tokens and dice, one for the sand timer and, finally, one for the dictionary.

The box cover will contain representations of all the symbols found on the board (the different squares, the Orus eye, etc.).

GAME DYNAMICS: One can envision many possible versions of this game just by making use of parts of it (as for instance, one type of question like GUESS THE WORD or WORDING SUBSTITUTING IMAGE) in such a way that the game could be played not only by teams but also by single players on a computer terminal, a mobile phone, a display console, a television or any other electronic devise that permits the visualization of photos. It is easy to envision a game that consists for instance in a set of GTW questions with three different degrees of difficulty. In this particular embodiment, the player will obtain a score (e.g. the number of correct answers in a row, the time to complete a set of questions, etc.) and being included in a score ranking that can be as local or worldwide as wished as is well known in the art.

A preferred application of the invention in this disclosure is a board game. This type of interface needs a minimum of four players divided into two teams (minimum two players per team). Although this is the minimum requirement there is an almost unlimited number of players that can be part of the different teams (a maximum of four teams can play simultaneously in the physical game board but there could be a theoretically unlimited number of players in an online version of the game or in other versions that could escape the limitation of the four sides of the pyramid).

The square zero contains a finger pointing in the direction of the game. That will be the start point where all the players (empty columns, distinguishable by the color of the base). To advance the team at play will throw two dice and will advance the same number of boxes as their sum. In another variation (the slower game), the game will be played with only one dice.

GAME RULES: To start the game, each team will choose a color and place the corresponding token (Hathor column) on the case number 0, that is identified by a pointing finger of the same color.

Before the start, the order of play will be decided by throwing the two dice. The team with the highest score will be the first to play and thereafter, the play will run counter-clockwise (red after yellow; yellow after green; green after blue; blue after red).

The board game is a social game and as such, a preferred way to play it is by making up playing teams that, through each of the team members, draw the necessary skills to play with chances of winning it. After my own experience playing the English version of the game for non-English speaking people, I have reached the provisional conclusion that every team ideally should have at least two main abilities: an intermediate-high level of English that will allow the player to draw the right answer in English and a good integrative deductive intelligence, that will help identify the right concept encoded in the icon images of the image card. These two minimally required features can be present in the same individual but it is preferred (and perhaps more fun) that they be the result of team making. Exceptionally, a winning team can be made without a high knowledge of English, perhaps by managing exceptionally well all the helping tools (like leads, consultation tokens, etc.) available to players.

Each player (team or individual) will be identified by a colour code (all the tools and tokens of a player will have the same colour code). Each player will have a player's token that will be the indicator of the player's performance throughout the game. The player's token is a transparent cylinder with a broad base (like in classic roman or Greek columns) that will be opaque and coloured with the player's distinctive colour). The counting of player performance (advance upwards the race path (typically a pyramid: see below) will be done by piling up the tablet like tokens (the pillars) that are designed to fit into the player cylinder. Upon completion of the last part of the game, the player will obtain the last degree token. The last token will approximately fill the cylinder cavity, after what the cylinder will be capped with the graduation cap (only after completing the last challenge).

The game will start by placing all the players at case 0. Also, as an option (and particularly depending on the player's priorities, including the amount of foreseeable time available to play or the language knowledge), the game can start at any consensual place. Particularly interesting for this purpose is the number one case of the intermediate (silver) level. In any case, the game will always follow the same direction (in the ordinal increasing number direction or the direction indicated by half arrows). The players determine who goes first by rolling a dice. The higher roll gets to go first. Play proceeds clockwise around the table, each person taking a turn. The first action on each person's turn is to roll the dice and advance a number of cases according to the toss number. When reached the corresponding case, the player can alternatively land on any of the variety of cases that are described above. Upon disclosure of the question corresponding to the landing square, the team will have 60″ to give the definitive written answer. In the same toss, the player will have the option of consulting a dictionary or any information means that could help to find the right answer. In a preferred version of the game, dictionary consultation is free within the time frame of 60″ but other possible versions of the game could use tokens of any shape and size that will be “paid” in exchange for the right to make the consultation. In other possible versions of the game, the player could also ask for a lead or a hint that could help finding the right answer. In exchange, the player ought to pay a lead token to the game bank. This kind of leads could preferably be represented in the back side of image cards. Leads could be I) grammatical leads consisting in phrases that miss only the key word encoded by the images of the image card, II) phonetic leads consisting in an image whose encoded word sounds like a part or a whole of the word encoded by the image card. In this version of the game (a game with tokens for consultation or for other helping tools), at the beginning of the game, the players will automatically have a stock of five consultation tokens and five lead tokens (although any other number of tokens could be chosen depending of the degree of difficulty that one can impinge on the game). Answers are considered correct when: a) They are the same as the correct answer that is written in the back part of the image card (players are allowed one misspelling per word—a change in only one letter) or b) they are included in the list of authorized synonyms (also listed in the back of the image card). Then, if the answer is approved as correct, the player is allowed to throw the dice again, repeating the same operation. A player that finally lands on the advanced certificate case (the golden Horus Eye) automatically gets a high level cylinder (pillar) that recognizes the achievement of reaching the high degree of knowledge in the game language. But, in order to get the graduation cap (the head of the Hathor goddess), players having reached need to answer a set of three gold questions (as in any other Horus Eye that they can choose among high level exam questions and high level image cards. The first team to complete this last test will be considered the winner of the game and will accordingly be bestowed with the graduation cap.

1. What is claimed is a series of processes and methods designed to improve language learning abilities, comprising:
A combination of pictures, wherein all said pictures have in common their relationship to a unique word.
A combination of a variety of pictures together with a single word wherein at least one of the pictures is related to that word.
A type of multi-choice test, wherein the header of said test is partially or totally substituted by a picture.
The combination of pictures and words, wherein words and pictures are interchangeable language units and images are called WORD SUBSTITUTING IMAGEs.

2. The invention of claim 1, comprising a variety of pictures together with a single phrase, wherein at least one of the pictures is related to that phrase.

3. The invention of claim 1, comprising a variety of pictures together with a single sentence, wherein at least one of the pictures is related to that sentence.

4. The invention of claim 1, wherein said processes are the basis for a questions and answers game to be played on a data storage device.

5. The game of claim 4, comprising a combination of pictures, wherein all said pictures have in common their relationship to a unique word.

6. The game of claim 4, comprising a combination of a variety of pictures together with a single word wherein at least one of the pictures is related to that word.

7. The game of claim 4, wherein said device is a computer terminal

8. The game of claim 4, wherein said device is a smart mobile phone

9. The invention of claim 1, wherein said processes are used in a board game comprising:
Cards, further comprising several types of questions: a GUESS THE WORD question, further comprising several pictures representing the same single word; a Header Substituting Photo multi-choice test, further comprising a picture and a multi-choice option text; and finally a SAY THE WORD/WRITE THE WORD question enunciate, further comprising one single word written in the native language of the player. The back side of the cards further comprising the correct answers to the questions in said front side.
A game board further comprising a pyramid of knowledge converted into four identical zigzag shaped game circuits. The cases of said circuit having the shape of pyramid pillars. The game track starting at case number 0. Further comprising throughout the game route a plurality of said cases (THE BARGE, THE CRYPT, COLLAPSE, THE THREE DIFFERENT ORUS EYES, THE SETH SQUARE, GO TO THE LIBRARY SQUARE, GUESS THE WORD QUESTION, IMAGE SUBSTITUTING QUESTION, MULTIIMAGE QUESTION, SAY THE WORD QUESTION, WRITE THE WORD QUESTION).
A game kit comprising a) cards of three levels of difficulty (bronze, silver and gold); b) c) boxes to fit the different types of said cards; e) consultation and lead tokens; f) player's advance token (a transparent cylinder on a coloured base); i) a graduation cap representing the head of the goddess Hathor that fits into the players cylinder token; j) two six faced dice; k) a card magnifier; l) a dictionary for the game version designed to practice a foreign language; a game box containing a foamy poked frame to hold the individual pieces of the game.

10. The game of claim 9, wherein the text in said HEADING SUBSTITUTING IMAGE multi-choice question, said word in said MULTIPICTURE question, as well as the right answers in the back of said cards are written in one language (language A) and the game instructions (as defined in the specification) as well as the word of the SAY THE WORD/WRITE THE WORD question in a different language (language B).

11. The game of claim 9, wherein language A and language B are the same language

12. The game of claim 9, wherein language A is English and language B, Spanish

13. The game of claim 9, wherein language A is Spanish and language B, English

14. The game of claim 11, wherein said same language is English.

15. The game of claim 11, wherein said same language is Spanish.

16. The game of claim 9, as the basis for a card collection

17. The game of claim 16, wherein said cards contain only one type of question (GUESS THE WORD, or WORDING SUBSTITUTING IMAGE, or MULTIPICTURE questions).
